(19) United States
(12) Patent Application Publication
(10) Pub. No.: US 2008/0193803 A1
(43) Pub. Date: Aug. 14, 2008

(54) Precursor Infiltration and Coating Method

(75) Inventors: Tal Z. Sholklapper, West Hills, CA (US); Craig P. Jacobson, El Cerrito, CA (US); Steven J. Visco, Berkeley, CA (US); Lutgard C. De Jonghe, Lafayette, CA (US)

Correspondence Address: BEYER WEAVER LLP, P.O. BOX 70250, OAKLAND, CA, 94612-0250, US

(73) Assignee: THE REGENTS OF THE UNIVERSITY OF CALIFORNIA, Oakland, CA (US)

(21) Appl. No.: 11/911,959

(22) PCT Filed: Apr. 21, 2006
(86) PCT No.: PCT/US2006/015196

§ 371 Date: Mar. 26, 2008

Related U.S. Application Data
(60) Provisional application No. 60/674,130, filed on Apr. 21, 2005.

(51) Int. Cl. H01M 4/00; B05D 3/02; B05D 5/12; C25B 11/04; B05D 7/22

(52) U.S. Cl. 429/12; 427/226; 427/123; 427/230; 204/280

(57) ABSTRACT

A method of forming a composite (e.g., a mixed electrode) by infiltration of a porous structure (e.g., one formed from an ionically conductive material) with a solution of a precursor (e.g., for an electronically conductive material) results in a particulate layer on and within the porous structure with a single infiltration. The method involves forming a solution comprising at least one metal salt and a surfactant; heating the solution to substantially evaporate solvent and form a concentrated salt and surfactant solution; infiltrating the concentrated solution into a porous structure to create a composite; and heating the composite to substantially decompose the salt and surfactant to oxide and/or metal particles. The result is a particulate layer on the pore walls of the porous structure. In some instances the particulate layer is a continuous network. Corresponding devices have improved properties and performance.

### STATEMENT REGARDING FEDERALLY SPONSORED RESEARCH OR DEVELOPMENT

This invention was made with government support under Grant (Contract) No. DE-AC02-05CH11231 awarded by The United States Department of Energy. The government has certain rights to this invention.

### BACKGROUND OF THE INVENTION

1. Field of the Invention

The present invention pertains generally to the field of solid state electrochemical devices. This invention relates to coatings on the surfaces of porous structures suitable for use in such devices to form composites. Such composites have applications for electrochemical systems such as fuel cells and oxygen generators, catalysts for hydrocarbon reforming and many other reactions, protective coatings for metals, ceramics, or polymers, and applications where an electronically conductive and/or an ionically conductive or an insulating layer is needed.

2. Description of Related Art

Solid state electrochemical devices are often implemented as cells including two porous electrodes, the anode and the cathode, and a dense solid electrolyte and/or membrane which separates the electrodes. For the purposes of this application, unless otherwise explicit or clear from the context in which it is used, the term “electrolyte” should be understood to include solid oxide membranes used in electrochemical devices, whether or not potential is applied or developed across them during operation of the device. In many implementations, such as in fuel cells and oxygen and syn gas generators, the solid membrane is an electrolyte composed of a material capable of conducting ionic species, such as oxygen ions, or hydrogen ions, yet has a low electronic conductivity. In other implementations, such as gas separation devices, the solid membrane is composed of a mixed ionic electronic conducting material (“MIEC”). In each case, the electrolyte/membrane must be dense and pinhole free (“gas-tight”) to prevent mixing of the electrochemical reactants. In all of these devices a lower total internal resistance of the cell improves performance.

The ceramic materials used in conventional solid state electrochemical device implementations can be expensive to manufacture, difficult to maintain (due to their brittleness) and have inherently high electrical resistance. The resistance may be reduced by operating the devices at high temperatures, typically in excess of 900° C. However, such high temperature operation has significant drawbacks with regard to the device maintenance and the materials available for incorporation into a device, particularly in the oxidizing environment of an oxygen electrode, for example.

The preparation and operation of solid state electrochemical cells is well known. For example, a typical solid oxide fuel cell (SOFC) is composed of a dense electrolyte membrane of a ceramic oxygen ion conductor, a porous anode layer of a ceramic, a metal or, most commonly, a ceramic-metal composite (“cermet”), in contact with the electrolyte membrane on the fuel side of the cell, and a porous cathode layer of a mixed ionically/electronically-conductive (MIEC) metal oxide on the oxidant side of the cell. Electricity is generated through the electrochemical reaction between a fuel (typically hydrogen produced from reformed methane) and an oxidant (typically air). This net electrochemical reaction involves charge transfer steps that occur at the interface between the ionically-conductive electrolyte membrane, the electronically-conductive electrode and the vapor phase (fuel or oxygen). The contributions of charge transfer step, mass transfer (gas diffusion in porous electrode), and ohmic losses due to electronic and ionic current flow to the total internal resistance of a solid oxide fuel cell device can be significant.

Previous work in the field has seen the development of a technique for fabrication of such solid state electrochemical device fabrication that involves the formation of a composite, or mixed, electrode, typically the cathode in a SOFC for example. A mixed cathode comprises ionically and electronically conductive components. It has been found to be advantageous to infiltrate a porous structure formed from the ionically conductive component with a suspension of solution of a precursor for the electronically conductive component in the formation of the mixed electrode.

However, conventional infiltration does not result in a connected network of the electronically conductive component after a single infiltration, and so typically several infiltration and heat cycles are required to form a connected network. Prior infiltration techniques may also yield a low-purity electronically conductive component. Also, some conventional sintered electrodes require high temperatures, well matched thermal expansion coefficients, and chemical compatibility. The high firing temperature of conventional electrodes (greater than 1000° C.) results in relatively large particle size, lower surface area and therefore lower area for electrochemical reactions to take place. The high firing temperatures also limit the choice of materials.

At present, most solid oxide fuel cells (SOFCs) use 8 mol % yttria stabilized zirconia (YSZ) as the electrolyte, Ni—YSZ as the supporting anode, and La₁₋ₓSrₓMnO_{3-δ} (LSM)-YSZ as the cathode. The cells are typically operated at or above 800 C to achieve high specific power densities. Lowering cell-operation temperatures expands the materials choices, potentially suppressing degradation of SOFC components, and extending cell lifetimes. The lower temperatures do, however, require measures to minimize ohmic losses and to enhance oxygen reduction reaction catalysis. Thin-film electrolytes as well as alternative electrolytes with higher oxide-ion conductivity than that of YSZ have been extensively explored and have effectively reduced electrolyte ohmic losses.

At low temperatures the typical composite LSM-YSZ cathode becomes a major factor limiting cell performance because the catalytic activity of the cathode for oxygen reduction decreases dramatically. Various models have been proposed to develop a relationship between cathode performance, e.g., characterized by an effective charge transfer resistance, and its structure and catalytic properties. After some structural assumptions and simplifications, an effective charge transfer resistance, R_{ct}^{eff}, was derived by Virkar et al. (C. Tanner, K. Fung, and A. Virkar, J. Electrochem. Soc., 144, 21 (1997)) that could be expressed as

$${R}_{ct}^{eff} = \sqrt{\frac{{R}_{ct} L}{{σ}_{{O}^{2 -}} ( 1 - P )}} ,$$

which R_{ct} is the intrinsic averaged charge transfer resistance; L is the periodicity of the structural model, and could be taken to be the electrode pore spacing, and P is the electrode porosity; and σₒ_{^{2−}} is the ionic conductivity of electrolyte phase. In this model, the catalyst is assumed to form a thin, uniform layer on the pore walls of the electrode's YSZ network, which does not quite correspond to the usual structure of an YSZ-LSM composite cathode. Further, the oxygen ion conductivity, σₒ_{^{2−}}, the YSZ in composite electrodes is affected by other structural factors, such as the network connectivity that is in turn affected in the co-firing process by the presence of the LSM. An advantageous approach would therefore be first to form a well-connected oxygen ion-conducting network that can later be infiltrated with electrocatalysts well below the usual co-firing temperatures.

Catalyst infiltration is common practice for polymer membrane fuel cell electrodes, and has recently been introduced for SOFC electrodes. This method expands the set of viable electrode materials combinations, because of the elimination of thermal expansion mismatch and the suppression of possible deleterious reactions among the electrode materials if sintered at the high temperatures required for co-firing. Materials such as LSM provide not only catalytic sites for the oxygen reduction reaction, but also have high electronic conductivity. The latter requires, of course, a continuous LSM structure, and previously multiple infiltrations were necessary to infuse enough electrocatalysts in the electrodes for sufficient electron conduction (see, e.g., Y. Huang, J. M. Vohs, R. J. Gorte, J. Elechtrochem. Soc., 151 (4), A646 (2004), U.S. Pat. No. 5,543,239 and US 2005/0238796). Such multiple processing steps have hindered the practical application of infiltration approaches.

Accordingly, improved techniques for forming mixed electrodes for solid state electrochemical devices, and the resulting structures and devices are needed. In particular, an effective single-step infiltration technique to prepare high quality LSM-YSZ composite cathodes and other composite structures would be desirable. These techniques could also be applicable in other contexts to improve other devices and procedures.

### SUMMARY OF THE INVENTION

The present invention provides a method of forming a composite (e.g., a mixed electrode) by infiltration of a porous structure (e.g., one formed from an ionically conductive material) with a solution of a precursor (e.g., for an electronically conductive material) that results in a particulate layer on and within the porous structure with a single infiltration. The method involves forming a solution comprising at least one metal salt and a surfactant; heating the solution to substantially evaporate solvent and form a concentrated salt and surfactant solution (e.g., to between about 70 and 130° C.); infiltrating the concentrated solution into a porous structure to create a composite; and heating the composite to substantially decompose the salt and surfactant to oxide and/or metal particles (e.g., to greater than 500° C., but below 1000° C., for example 800° C.). The result is a particulate layer on the pore walls of the porous structure. In a preferred embodiment, the particulate layer is a continuous network.

This invention eliminates many of the deleterious elements of a mixed electrode consisting of a mixture of predominately electronically conductive catalytic particles and ionically conducting particles. It allows for lower electrode material sintering temperatures and therefore a larger possible material set. In addition the fine scale of the coating allows for the use of materials with thermal expansion coefficients that are not well matched. Separating the firing step of the porous ionic conducting framework (the porous electrolyte structure into which the electronically conductive catalyst precursor is infiltrated) also allows for optimizing the properties of the porous ionic network (for example, firing YSZ at higher temperatures results in improved ionic conductivity through the porous network). An additional advantage is that a very low volume percent (or weight percent) of an electronically conductive material is required to obtain an electronically connected network within a porous structure. This allows for the infiltration of complex compositions into porous structures that results in a continuous network after conversion of the precursor to an oxide, metal, mixture of oxides, or mixtures of metals and oxides.

While a single infiltration step resulting in a continuous network within a porous structure is beneficial to reducing the processing cost, the invention is not limited to only a single infiltration and include the possibility of multiple infiltrations wherein each infiltration is of a continuous network.

The invention also enables novel structures to be fabricated. For example, FeCrAlY alloys are well known in the art for their resistance to oxidation at high temperatures, however the high electronic resistance of the Al₂O₃ scaled formed during oxidation prevents their application as electronically conductive portions of electrochemical devices such as solid oxide fuel cells. The infiltration of a continuous electronically conductive networks allows a porous support structure to be fabricated from the FeCrAlY or FeAl or Fe₃Al or Ni₃Al or similar Al₂O₃ forming alloy. A porous ionic conducting layer in contact with a dense ionically conducting layer can be applied to this porous Al₂O₃ forming alloy and the continuous electronically conducting layer, such as Cu or Co or Ni with or without doped ceria, or LSM can then be infiltrated.

These and other aspects ands advantages of the present invention are more fully described and exemplified in the detailed description below with reference to the figures.

### BRIEF DESCRIPTION OF THE DRAWINGS

FIG. 1 shows a schematic of a process in accordance with the present invention resulting in a continuous network of LSM inside a YSZ pore.

FIG. 2 shows a SEM micrograph of a continuous LSM network within a porous YSZ framework in contact with a dense YSZ electrolyte (SOFC cathode structure) formed in accordance with the infiltration technique of the present invention.

FIG. 3 shows XRD patterns of the decomposition products from LSM precursors without (a) and with the surfactant (Triton X-100) (b) processed in accordance with the infiltration technique of the present invention.

FIG. 4 is a plot of voltage and power vs. current density at 923K for a cell with an infiltrated LSM-YSZ cathode in accordance with the present invention.

FIG. 5 shows plots of impedance spectra at 923K for a cell with a non-infiltrated cathode (a) and with the infiltrated LSM-YSZ cathode in accordance with the present invention (b).

FIG. 6 shows a schematic cross-sectional view through support and electrode in contact with dense electrolyte layer for an alternative embodiment using the infiltration technique of the invention.

FIG. 7 is a plot of voltage and power vs. current density at 973K for a cell with an infiltrated LSF cathode in accordance with the present invention.

FIG. 8 shows plots of impedance spectra at 923K for a cell with a LSF infiltrated cathode (a) and with the infiltrated LSF infiltrated with additional Co in accordance with the present invention (b).

FIG. 9 is a plot of voltage and power vs. current density at 973K for a cell with an infiltrated Ag cathode in accordance with the present invention.

FIG. 10 is a plot of voltage and power vs. current density at 923K for a cell with infiltrated LSM, Ag, and LSM-Ag cathodes in accordance with the present invention.

### DETAILED DESCRIPTION OF SPECIFIC EMBODIMENTS

Introduction

As noted above, infiltration of precursors into porous structures is well known in the art. However, repeated infiltration and firing steps have been needed to create an interconnected network of the infiltrated material. What is needed is a method of forming a high quality continuous network of fine particles on the pore walls of a porous structure in a single step.

The present invention provides a method of forming a composite, such as a mixed electrode for an electrochemical device, by infiltration of a porous structure with a solution of a precursor that results in a particulate layer on the walls of the porous structure with a single infiltration. The method involves forming a solution comprising at least one metal salt and a surfactant; heating the solution to substantially evaporate solvent (e.g., the temperature of the solution is raised near or above the solvent (e.g., water) boiling point to remove as much solvent as possible) and form a concentrated salt and surfactant solution; infiltrating the concentrated solution into a porous structure to create a composite; and heating the composite to substantially decompose the salt and surfactant to oxide and/or metal particles. The result is a particulate layer on the pore walls of the porous structure. In a preferred embodiment, the particulate layer is a continuous network.

This combination of heat, surfactant, and concentrated salt solution provides improved results in terms of single step coating coverage that was not previously attainable. This technique also produces a pure (single phase) coating material that provides superior performance. In a preferred implementation, the porous structure is an ionically conductive material (e.g., YSZ) that is infiltrated with a solution of a precursor for an electronically conductive material with a single infiltration. In other embodiments, the porous substrate can be a mixed ionic-electronic conductor MIEC (e.g., a composite LSM/YSZ substrate) or an electronic conductor (e.g., a porous metal), such as detailed in the Examples below.

Infiltration Method and Structures

An important aspect of the present invention is the particular way in which a surfactant is combined with one or more metal salts prior to infiltration of the porous structure. Surfactants are known to improve the wetability of solutions infiltrated into porous structures. It has now been found that by heating an infiltrate solution containing a metal salts(s) and surfactant near to or above the boiling point of the solution's solvent to remove most or all of the solvent prior to infiltration has beneficial results. Typically a solution of infiltrate is formed from metal salt(s), a solvent (typically water or an alcohol) and a surfactant. Substantial removal of the solvent prior to infiltration has been found to improve the infiltration such that coverage resulting in the formation of a continuous network of the infiltrated material after firing of the composite can be achieved with a single infiltration step. In addition, the quality of the resulting continuous network has been found to be high; in particular, single phase (phase pure) perovskite has been found to result from this process when LSM forming metal salts are infiltrated in this way. These results have been obtained for a variety of substrate and infiltrate materials including ionically, MIEC and electronically conducting porous substrates; and infiltrate solutions formed from a single or multiple metal salts and a variety of surfactants. The scope of the invention encompasses all these instances, as well as others.

A process flow noting relevant aspects of an infiltration method in accordance with the present invention is:
Step 1: Provide a porous structure.
Step 2: Create a concentrated precursor solution by heating a mixture of metal salt(s) with a surfactant, such as Triton X-100 (Union Carbide Chemicals and Plastics Co., Inc.), or other appropriate surfactant, to remove solvent (e.g., water) from the solution.
Step 3: Infiltrate the concentrated precursor solution into the porous structure, preferably by vacuum infiltration.
Step 4: Convert the precursor to a coating by decomposing the precursors by heating above 500° C. (e.g., about 500-800° C., such as about 800° C.) in air or by reducing the precursor to a metal by heating above 200° C. in a reducing atmosphere (e.g., H₂).

The result is a particulate layer, that is preferably a continuous network in many embodiments, on the pore walls of the porous structure.

Step 2 above should occur at a temperature above the melting point of the surfactant and at least some of the metal salt(s) and near (e.g., slightly above) the boiling point of the solvent, but preferably below the boiling point of the liquid metal salts so that the metal salts are not decomposed prior to infiltration. The melting points (MP) and boiling points (BP) of several typical materials used in accordance with the present invention are shown below:
23° C. MP Triton X-100
37° C. MP Mn(NO₃)₂
40° C. MP La(NO₃)₂
100° C. BP H₂O
126° C. BP Nitrates (stop before boiling point of nitrates, to infiltrate)
270° C. BP Triton X-100
570° C. MP Sr(NO₃)₂ (Use H₂O to dissolve)
   Suitable heating temperatures for step 2 are typically in the 70 to 130° C. range, depending upon the solvent and salts used.

Triton X-100 (octylphenol ethoxylate) is a nonionic surfactant noted above as suitable for use in accordance with the present invention. Any suitable surfactant may be used in accordance with the present invention including nonionic, anionic, cationic, and polymeric surfactants. Other examples include polymethylmetacrylic ammonium salt (PMMA) (e.g., Darvan C, R.T. Vanderbilt Co.) and polyethylene glycol.

While the invention is not limited by any particular theory of operation, it is believed that lowering the surface tension of the solution and/or foaming of the surfactant in the infiltrated metal salt solution during decomposition of the heated metal salts plays a role in the superior performance of the method of the present invention. The foaming is believed to arise from outgassing from the metal salts during their decomposition. The precursor preferentially wets and adheres to the surfaces of the porous material during the outgassing resulting in a coating.

The invention will now be described in further detail with reference to specific embodiments in which mixed cathodes are fabricated for a solid oxide fuel cell. It should be understood, however, that the invention is applicable more generally to the infiltration of porous substrates in conjunction with the fabrication of other electrochemical devices and devices and structures of other types.

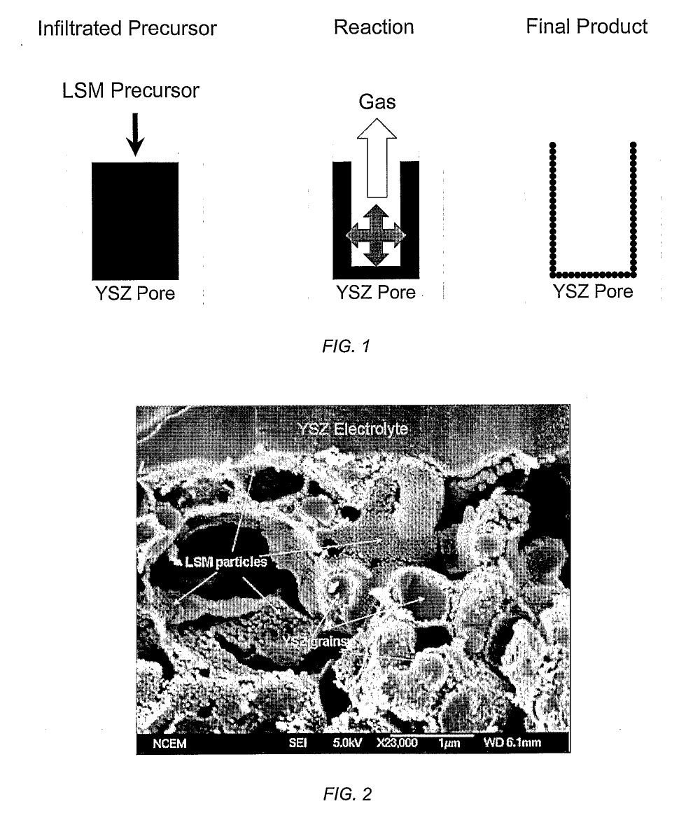

Referring to FIG. 1, a schematic of a process in accordance with the present invention resulting in a continuous network of LSM (electronically conductive material) inside a YSZ (ionically conductive material) pore. With reference to the process flow above, steps 3 (infiltration) and 4 (reaction) and the final product are shown. The porous structure of step 1 is composed of YSZ; typically a porous coating of YSZ on a dense layer of YSZ electrolyte. The concentrated precursor solution of step 2 is a LSM (La_{.85}Sr_{.15}MnO₃) (electronically conductive material) precursor solution that can be prepared by adding lanthanum nitrate, strontium nitrate, manganese nitrate hydrate, Triton X-100 and enough water to dissolve the nitrates. The solution is then heated (e.g., to about 110° C. or 120° C.) to evaporate most or all of the water in the solution (both the water added to the solution and that held by the nitrates).

Referring to the figure, in the first image the hot solution (e.g., about 100° C.) is then infiltrated in the YSZ pores. This can be accomplished by drop wise addition to the porous YSZ layer followed by vacuum impregnation. In the second image, after infiltration the porous structure is fired at a relatively low temperature (e.g., 800° C.) to react the precursors in the solution to form the continuous network of LSM in the YSZ pores shown in the final image.

FIG. 2 shows a SEM micrograph of a continuous LSM network within a porous YSZ framework in contact with a dense YSZ electrolyte (SOFC cathode structure) formed in accordance with the infiltration technique of the present invention described above. The cathode is composed of YSZ grains, pores, and infiltrated LSM particles with a size of about 30-100 nm. The LSM particles appear preferentially to coat the pore walls of the YSZ network, forming in may instances a fairly densely packed, single layer of nanosized LSM particles, as shown in the inset. The LSM particles are generally in intimate connect with each other, allowing for sufficient electronic connectivity. The layer of the nanoparticles is interesting, since with sufficient ionic conductivity the entire surface of the particles can participate in catalysis. These morphologies can be far more effective than those in some conventional cathodes where at about 50-50 wt % of the LSM and YSZ form large-scale interpenetrating structures. In contrast, the infiltrated LSM produced here is only about 6 wt % of the YSZ network.

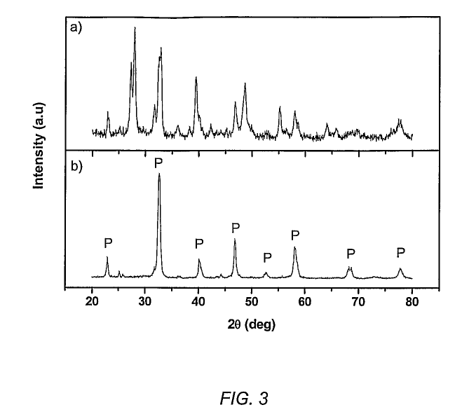

FIG. 3 shows XRD patterns of the decomposition products from LSM precursors without (a) and with the surfactant (Triton X-100) (b) processed in accordance with the present invention described above. Post infiltration heating was in air at 1073K for 1 hour. (P) Peaks corresponding to perovskite phase. As indicated in (a), directly decomposing nitrate precursors at 1073K does not yield a phase-pure LSM perovskite. In contrast, with the use of the concentrated precursor solution containing surfactant, the majority of characteristic peaks in (b) correspond to the perovskite phase.

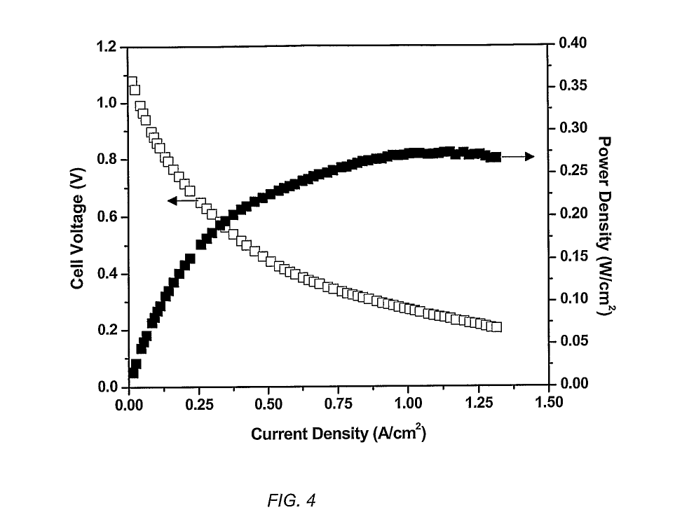

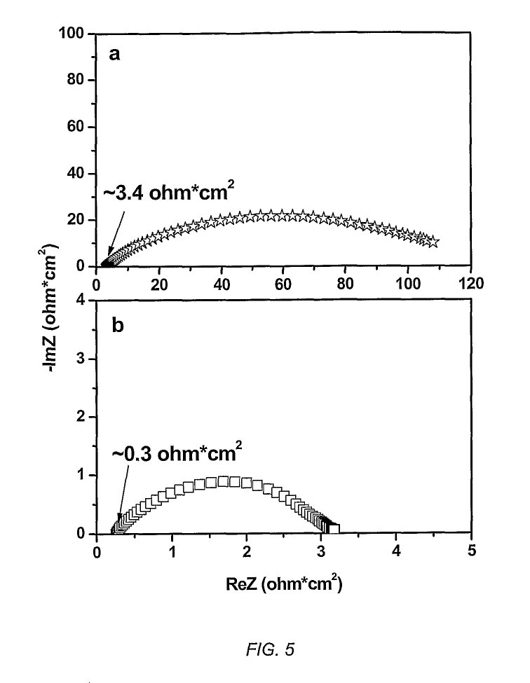

The performance of LSM-YSZ mixed cathodes fabricated in accordance with the present invention as described herein was measured. Results are shown in FIG. 4 (I-V curves) and FIG. 5 (impedance plots including a spectrum corresponding to a non-infiltrated cell). FIG. 4 is a plot of voltage and power vs. current density at 923K for a cell with an infiltrated LSM-YSZ cathode in accordance with the present invention. The LSM-YSZ cathode displays a promising performance at 923K; cell open circuit voltage is about 1.1V, and maximum power density is about 0.27 W/cm². FIG. 5 shows plots of impedance spectra at 923K for a cell with a non-infiltrated cathode (a) and with the infiltrated LSM-YSZ cathode (b). The impedance for the non-infiltrated cell at near-OCV. The cell ohmic resistance (Rᵣ), determined from the high-frequency intercept on the real axis, combines the ohmic loss from the cell anode, electrolyte, and cathode. The infiltrated cell has an Rᵣ of ˜0.3 Ω*cm², while the R, for the non-infiltrated cell is ˜3.4 Ω*cm². Since both cells have similar anodes, electrolytes and porous YSZ networks, this significant difference in the Rᵣ's implies that the infiltrated LSM particles in the porous YSZ network impart sufficient electronic conductivity to the resulting LSM-YSZ cathode. In addition, the polarization resistance for the infiltrated cell is ˜2.9 Ω*cm², strikingly smaller than the ˜110 Ω*cm² for the non-infiltrated cell. Therefore, it is the infiltrated LSM, not the Pt electrode paste that provides sufficient active reaction sites for electrochemical reduction of oxygen.

While a single infiltration step resulting in a continuous network within a porous structure is beneficial to reducing the processing cost, the invention is not limited to only a single infiltration and include the possibility of multiple infiltrations wherein each infiltration is of a continuous network.

The invention also enables novel structures to be fabricated. For example, FeCrAlY alloys are well known in the art for their resistance to oxidation at high temperatures, however the high electronic resistance of the Al₂O₃ scaled formed during oxidation prevents their application as electronically conductive portions of electrochemical devices such as solid oxide fuel cells. The infiltration of a continuous electronically conductive networks allows a porous support structure to be fabricated from the FeCrAlY or FeAl or Fe₃Al or Ni₃Al or similar Al₂O₃ forming alloy. A porous ionic conducting layer in contact with a dense ionically conducting layer can be applied to this porous Al₂O₃ forming alloy and the continuous electronically conducting layer, such as Cu or Co or Ni with or without doped ceria, or LSM can then be infiltrated.

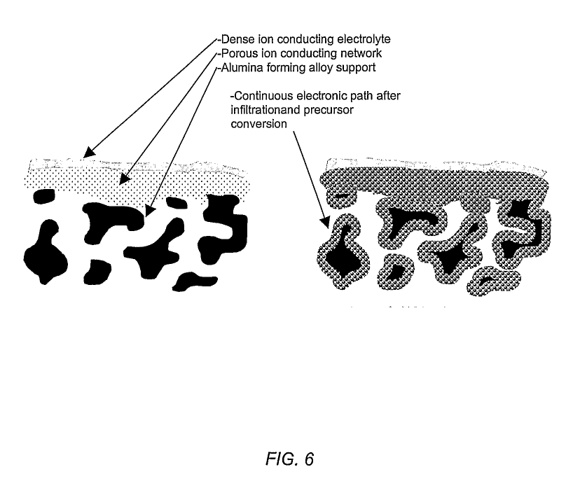

FIG. 6 illustrates such an alternative embodiment using the infiltration technique of the invention. A schematic cross-sectional view through support and electrode in contact with dense electrolyte layer is shown. Infiltration in accordance with the invention forms a continuous electronically conductive network. In this drawing the support is an electronically insulating material such as oxidized FeCrAlY, though an electronically conductive material could also be used.

Alternatively, superior electrocatalysts such as lanthanum strontium cobalt oxide (LSC) could be infiltrated into a porous YSZ or CGO network to form high-performance cathodes for intermediate temperature SOFCs.

Advantages

This invention eliminates many of the deleterious elements of a mixed electrode consisting of a mixture of predominately electronically conductive catalytic particles and ionically conducting particles. It allows for lower electrode material sintering temperatures and therefore a larger possible material set. In addition the fine scale of the coating allows for the use of materials with thermal expansion coefficients that are not well matched. Separating the firing step of the porous ionic conducting framework (the porous electrolyte structure into which the electronically conductive catalyst precursor is infiltrated) also allows for optimizing the properties of the porous ionic network (for example, firing YSZ at higher temperatures results in improved ionic conductivity through the porous network). An additional advantage is that only a very low volume percent (or weight percent) of an electronically conductive material is required to obtain an electronically connected network within a porous structure. This allows for the infiltration of complex compositions into porous structures in a single step that results in a continuous network after conversion of the precursor to an oxide, metal, mixture of oxides, or mixtures of metals and oxides. Finally, the technique of the invention has been found to produce a high quality continuous network of single phase perovskite on a porous substrate.

### EXAMPLES

The following examples provide details relating to the practice and advantages of an infiltration method in accordance with the present invention. It should be understood the following is representative only, and that the invention is not limited by the detail set forth in these examples.

### Example 1

### Fabrication of Anode Supported SOFC with LSM Infiltration

The anode portion of an anode/electrolyte/cathode structure was formed by tape casting a mixture of NiO(50%)/YSZ(50 wt %). The mixture of NiO/YSZ was prepared by ball milling 12.5 g of NiO (Nickelous Oxide, Green (available from Mallinckrodt Baker, Phillipsburg, N.J.), 12.5 g of YSZ (Tosoh TZ-8Y (available from Tosoh Ceramics, Boundbrook, N.J.) and 1 mL of Duramax D-3005 (available from Rohm and Haas, Philadelphia, Pa.) in 16 mL of water for 1 day. Afterwards 6 mL of Duramax B-1000 and 4 mL of Duramax HA-12 (both available from Rohm and Haas, Philadelphia, Pa.) are added and all excess water was evaporated while the solution was stirred in an air environment. The solution was then tape casted and allowed to dry overnight. The resulting green tape was cut into 1.5 inch diameter Disks. The disk was fired to burn out the binders and sinter the structure, according to the following schedule: heat room temperature (RT) to 600° C. at 1° C. per min., hold for 1 hour, 600° C. to 1100° C. at 3° C. per min., hold for 4 hours, cool 1100° C. to RT at 5° C. per min.

After cooling, a thin coating of YSZ (the ionically-conductive electrolyte material) was applied to the NiO/YSZ disk by uniformly spraying an YSZ suspension by an aerosol spray method. The suspension was prepared by attritor milling 2 g of YSZ, 0.1 g of fish oil (fish oil from Menhaden (available from Sigma-Aldrich, St. Louis, Mo.) and 0.01 g dibutyl phthalate (available from Mallinckrodt Baker) in 50 mL of Isopropyl Alcohol (IPA), for 1 hour. The suspension was sprayed while the NiO/YSZ disk was held at 150° C. (0.037 g of final dried YSZ was deposited, typically yielding a sintered YSZ electrolyte membrane about 10 μm thick). The disk was fired to burn our binders and sinter the structure, according to the following schedule: heat room temperature (RT) to 600° C. at 3° C. per min., 600° C. to 1400° C. at 5° C. per min., hold for 4 hours, cool 1400° C. to RT at 5° C. per min.

After cooling, a suspension of YSZ (35 vol %, ion-conductive material), and graphite (65 vol %, fugitive pore-forming material) was uniformly sprayed, by aerosol spray method, to a 1 cm² area on the electrolyte surface. The suspension was prepared by attritor milling 1.28 g YSZ (Tosoh TZ-8Y), 0.1 g fish oil (fish oil from Menhaden (Sigma-Aldrich) and 0.01 g dibutyl phthalate in 50 mL of IPA, for 1 hour. Afterwards 0.72 g of graphite (KS4 (available from Timcal Group, Quebec, Canada) was added and sonicated for 5 min. The electrolyte surface has been covered to only reveal a 1 cm² area which was then uniformly sprayed with the suspension, while being held at 150° C. (0.007 g of final dried YSZ/graphite was deposited, typically yielding a sintered porous YSZ membrane about 10 μm thick). The disk was fired to burn our fugitive pore formers and binders and sinter the structure, according to the following schedule: heat room temperature (RT) to 600° C. at 3° C. per min., 600° C. to 1300° C. at 5° C. per min., hold for 4 hours, cool 1300° C. to RT at 5° C. per min.

After cooling, the porous YSZ layer was infiltrated with an LSM (La_{.85}Sr_{.15}MnO₃) (electronically conductive material) precursor solution. The solution was prepared by adding 3.144 g La(NO₃)₃.6H₂O (Lanthanum (III) nitrate, 99.9% (REO) (available from Alfa Aesar, Ward Hill, Mass.), 0.271 g Sr(NO₃)₂ (Strontium Nitrate, ACS, 99.0% min (Assay) (available from Alfa Aesar), 2.452 g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the nitrates). The solution was then heated to 120° C. to evaporate the water in the solution (both the water added to the solution and that held by the nitrates). When the solutions internal temperature begins to rise above 100° C. all of the water has been evaporated. The hot solution (about 100° C.) was then added drop wise to the porous YSZ layer (the remaining electrolyte surface has again been covered to limit the infiltration area to 1 cm²) and vacuum impregnated. After drying at 120° C. for 30 min. the disk was fired according to the following schedule: heat room temperature (RT) to 800° C. at 3° C. per min., hold for 1 hour, cool 800° C. to RT at 5° C. per min.

After cooling, all excess LSM was removed from the cathode surface and a thin layer of platinum paste (available from Heraeus, Inc.) was applied to the anode face and to the 1 cm² cathode face. The platinum paste was dried under heat lamp for 30 min. Afterwards, platinum mesh was attached to the anode and cathode faces with platinum paste, to serve as a current collector. The cell assembly was then fired according to the following schedule: heat room temperature (RT) to 800° C. at 3° C. per min., hold for 1 hour, cool 800° C. to RT at 5° C. per min.

The single cells were sealed onto an alumina tube using Aremco-552 cement, and current-voltage characteristics were obtained, using 97% H₂+3% H₂O as the fuel and air as the oxidant. The cell performance was determined from 600-800° C. with a Solartron 1255 frequency response analyzer combined with a Solartron 1286 electrochemical interface. The impedance spectra were measured under near-open circuit conditions (OCV), using a 10 mV amplitude AC signal over a frequency range of 0.1 Hz to 1 MHz. The DC current-voltage (I-V) performance was recorded with a potentiostat-galvanostat (Princeton Applied Research Model 371). After the electrochemical characterization the cells were fractured and the microstructures were examined with a JEOL 6400 scanning electron microscope (SEM). In addition, the phase formation was examined using a diffractometer (Siemens D-500) with C radiation in the 20 range from 200 to 800. Results are illustrated in FIGS. 3, 4 and 5, discussed above.

### Example 2

### Fabrication of Thick Electrolyte Infiltration of Anode and Cathode

An anode/electrolyte/cathode structure was prepared on an electrolyte-supported cell, which was formed by pressing a 1′ inch diameter disk from 0.9 g of YSZ. The YSZ was prepared by attritor milling 25 g of YSZ (Tosoh TZ8Y) and 0.625 g each of fish oil (Sigma-Aldrich), dibutyl phthalate (Mallinckrodt Baker) and poly(vinyl butyral-co-vinyl alcohol-co-vinyl acetate) (available from Sigma-Aldrich) with 100 mL of (IPA), for 1 hour. The mixture was dried and then ground and sieved through a 100 mesh. The disk was fired to burn out the binders and sinter the structure, according to the following schedule: heat room temperature (RT) to 600° C. at 3° C. per min., 600° C. to 1400° C. at 5° C. per min., hold for 4 hours, cool 1400° C. to RT at 5° C. per min.

After cooling, a suspension of YSZ (35 vol %, ion-conductive material), and graphite (65 vol %, fugitive pore-forming material) was uniformly sprayed, by aerosol spray method, to a 1 cm area on both sides of the electrolyte surface. The suspension was prepared by attritor milling 1.28 g YSZ (Tosoh TZ-8Y), 0.1 g fish oil (fish oil from Menhaden (Sigma-Aldrich) and 0.01 g dibutyl phthalate (Mallinckrodt Baker) in 50 mL of IPA, for 1 hour. Afterwards 0.72 g of graphite (KS4 (available from Timcal Group, Quebec, Canada) was added and sonicated for 5 min. The electrolytes surfaces have been covered to only reveal 1 cm² areas which are then uniformly sprayed with the suspension, while being held at 150° C. (0.007 g of final dried YSZ/graphite was deposited, typically yielding a sintered porous YSZ membrane about 10 μm thick). The disk was fired to burn our fugitive pore formers and binders and sinter the structure, according to the following schedule: heat room temperature (RT) to 600° C. at 3° C. per min., 600° C. to 1300° C. at 5° C. per min., hold for 4 hours, cool 1300° C. to RT at 5° C. per min.

After cooling, one porous YSZ layer was infiltrated with an LSM (La_{.85}Sr_{.15}MnO₃) (electronically conductive material) precursor solution. The solution was prepared by adding 3.144 g La(NO₃)₃.6H₂O (Lanthanum (III) nitrate, 99.9% (REO) (available from Alfa Aesar, Ward Hill, Mass.), 0.271 g Sr(NO₃)₂ (Strontium Nitrate, ACS, 99.0% min (Assay) (available from Alfa Aesar), 2.452 g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the nitrates). The solution was then heated to 120° C. to evaporate the water in the solution (both the water added to the solution and that held by the nitrates). When the solutions internal temperature begins to rise above 100° C. all of the water has been evaporated. The hot solution (about 100° C.) was then added drop wise to the porous YSZ layer (the remaining electrolyte surface has again been covered to limit the infiltration area to 1 cm²) and vacuum impregnated. The disk was then dried at 120° C. for 30 min. The other porous YSZ layer was then infiltrated with NiO/CeO₂ (50-50 wt %)(anode material) precursor material. The solution was prepared by adding 2.520 g Ni(NO₃)₂.6H₂O (Nickel (II) nitrate; Reagent (available from Johnson Matthey Catalog Company, London, England), 1.214 g Ce(NO₃)₃.6H₂O (Cerium (III) nitrate, hexahydrate 99% (available from Sigma-Aldrich) and 0.3 g Triton X-100 (available from VWR, West Chester, Pa.) in 10 mL of water (enough to dissolve the nitrates). The solution was then infiltrated in the same method as LSM was on the opposite electrode. After drying the disk was fired according to the following schedule: heat room temperature (RT) to 800° C. at 3° C. per min., hold for 1 hour, cool 800° C. to RT at 5° C. per min.

After cooling, all excess LSM and NiO/CeO₂ was removed from the electrode surfaces and a thin layer of platinum paste (available from Heraeus, Inc.) was applied to both of the 1 cm² electrode faces. The platinum paste was dried under heat lamp for 30 min. Afterwards, platinum mesh was attached to the anode and cathode faces with platinum paste, to serve as a current collector. The cell assembly was then fired according to the following schedule: heat room temperature (RT) to 800° C. at 3° C. per min., hold for 1 hour, cool 800° C. to RT at 5° C. per min.

### Example 3

### Porous Disk

A porous structure was formed by pressing a 0.5 inch diameter disk from 0.3 g of a mixture of YSZ (35 vol %, ion-conductive material), and graphite (65 vol %, fugitive pore-forming material). The mixture of YSZ/graphite was prepared by attritor milling 10 g YSZ (Tosoh TZ-8Y), with 0.36 g each of fish oil (fish oil from Menhaden (Sigma-Aldrich), dibutyl phthalate (Mallinckrodt Baker) and poly(vinyl butyral-co-vinyl alcohol-co-vinyl acetate) (Sigma-Aldrich) in 100 mL of IPA, for 1 hour. Afterwards 5.67 g of graphite (KS4 (Timcal Group) was added and sonicated for 5 min. The mixture was dried and then ground and sieved through a 100 mesh. The disk was fired to burn out the binders and sinter the structure, according to the following schedule: heat room temperature (RT) to 600° C. at 3° C. per min., 600° C. to 1250° C. at 5° C. per min., hold for 4 hours, cool 1250° C. to RT at 5° C. per min.

A series of such porous structures were made and each one was infiltrated with a different catalyst precursor material including the following:

A LSM solution was prepared by adding 3.144 g La(NO₃)₃.6H₂O (Lanthanum (III) nitrate, 99.9% (REO) (available from Alfa Aesar, Ward Hill, Mass.), 0.271 g Sr(NO₃)₂ (Strontium Nitrate, ACS, 99.0% min (Assay) (available from Alfa Aesar), 2.452 g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the nitrates).

A SSC solution was prepared by adding 2.297 g Sm(NO₃)₃.6H₂O (Samarium (III) nitrate hexahydrate, 99.9% (available from Aldrich), 0.729 g Sr(NO₃)₂ (Strontium Nitrate, ACS, 99.0% min (Assay) (available from Alfa Aesar), 2.507 g Co(NO₃)₂.6H₂O (Cobalt (II) nitrate, ACS, 89% (from Alfa Aesar) and 0.3 g Triton X-100 (available from VWR, West Chester, Pa.) in 10 mL of water (enough to dissolve the nitrates).

A LSCF (La_{.60}Sr_{.40}Co_{.20}Fe_{.80}O_{3-δ}) solution was prepared by adding 2.332 g La(NO₃)₃.6H₂0 (Lanthanum (III) nitrate, 99.9% (REO) (available from Alfa Aesar, Ward Hill, Mass.), 0.797 g Sr(NO₃)₂ (Strontium Nitrate, ACS, 99.0% min (Assay) (available from Alfa Aesar), 0.522 Co(NO₃)₂.6H₂O (Cobalt (II) nitrate, ACS, 89% (from Alfa Aesar), 2.900 g Fe(NO₃)₃.9H₂O (Iron (III) nitrate nonahydrate 98+% A.C.S reagent (available from Aldrich) and 0.3 g Triton X-100 (available from VWR, West Chester, Pa.) in 10 mL of water (enough to dissolve the nitrates).

A LaCr_{.9}Mg_{.1}O₃ solution was prepared by adding 3.667 g La(NO₃)₃.6H₂O (Lanthanum (III) nitrate, 99.9% (REO) (available from Alfa Aesar, Ward Hill, Mass.), 3.050 g Cr(NO₃)₃.9H₂O (Chromium (III) nitrate nonahydrate, 99% (available from Aldrich), 0.217 g Mg(NO₃)₂.6H₂O (Magneseium nitrate hexahydrate 99% A.C.S reagent available from Aldrich) and 0.3 g Triton X-100 (available from VWR, West Chester, Pa.) in 10 mL of water (enough to dissolve the nitrates).

MnCo₂O₄: 2.425 Mn(NO₃)₂.6H₂O (Manganese (II) nitrate hydrate, 98% (available from Sigma-Aldrich), 4.917 g Co(NO₃)₂.6H₂O (Cobalt (II) nitrate, ACS, 89% (from Alfa Aesar) and 0.3 g Triton X-100 (available from VWR, West Chester, Pa.) in 10 mL of water (enough to dissolve the nitrates).

NiO—CeO₂ (50-50 volume %): 2.520 Ni(NO₃)₂.6H₂O (Nickel (II) nitrate, reagent (available from Johnson Matthey Catalog Company) 1.214 g Ce(NO₃)₃.6H₂O (Cerium (III) nitrate hexahydrate, REacton 99.5% (REO) (available from Alfa Aesar) and 0.3 g Triton X-100 (available from VWR, West Chester, Pa.) in 10 mL of water (enough to dissolve the nitrates).

Ce_{.8}Gd_{.2}O₃: 3.627 g Ce(NO₃)₃.6H₂O (Cerium (III) nitrate hexahydrate, REacton 99.5% (REO) (available from Alfa Aesar), 0.943 g Gd(NO₃)₃.XH₂O (X≈6) (Gadolinium (III) nitrate hydrate 99.9% (REO) (available from Alfa Aesar) and 0.3 g Triton X-100 (available from VWR, West Chester, Pa.) in 10 mL of water (enough to dissolve the nitrates).

Each of the solutions was then heated to 100° C. to evaporate most of the water in the solution (both the water added to the solution and that held by the nitrates). When the solution's internal temperature begins to rise above 100° C. most of the water has been evaporated. The hot solution (about 100° C.) was then added drop wise to the porous YSZ (the remaining electrolyte surface has again been covered to limit the infiltration area to 1 cm²) and vacuum impregnated. After drying at 120° C. for 30 min. the disk was fired according to the following schedule: heat room temperature (RT) to 800° C. at 3° C. per min., hold for 1 hour, cool 800° C. to RT at 5° C. per min.

### Example 4

### Anode Supported SOFC with LSCF Cathode

Preparation for cell support up to infiltration was the same as in Example 1.

After cooling, the porous YSZ layer was infiltrated with an LSCF (La_{.60}Sr_{.40}Co_{.20}Fe_{.80}O_{3-δ}) (electronically conductive material) precursor solution. The solution was prepared by adding 2.332 g La(NO₃)₃.6H₂O (Lanthanum (III) nitrate, 99.9% (REO) (available from Alfa Aesar, Ward Hill, Mass.), 0.797 g Sr(NO₃)₂ (Strontium Nitrate, ACS, 99.0% min (Assay) (available from Alfa Aesar), 0.522 Co(NO₃)₂.6H₂O (Cobalt (II) nitrate, ACS, 89% (from Alfa Aesar), 2.900 g Fe(NO₃)₃.9H₂O (Iron (III) nitrate nonahydrate 98+% A.C.S reagent (available from Aldrich) and 0.3 g Triton X-100 (available from VWR, West Chester, Pa.) in 10 mL of water (enough to dissolve the nitrates).

Processing after infiltration was the same as in Example 1.

### Example 5

### Porous Metal SOFC with YSZ Electrolyte and Infiltrated LSM Cathode and Ni—CeO₂ Anode

Stainless steel powder (type Fe30Cr from Ametek) was applied to a porous YSZ layer on both sides of a dense YSZ disk then at 1300° C. for 4 hrs in flowing 4% H₂/balance Ar. LSM and NiO—CeO₂ solutions were prepared as in Example 3 and infiltrated into opposite sides of the coated YSZ disk. The Pt leads were attached to the both sides of the cell which was then sealed at the end of an alumina tube as in Example 1. The electrodes were converted to the oxides during heat up to 600° C. The fuel cell was tested between 600-800° C. with air as the oxidant and H₂+3% H₂O as the fuel. After testing the cell was mounted in epoxy, cut and polished. SEM micrographs showed LSM infiltrated the porous YSZ structure as well as coated the porous metal.

### Example 6

### LSM Precursor Solution made Using a Hydroxide

LSM (La_{.85}Sr_{.15}MnO₃) precursor solution was produced using a mixture of salts. The solution was prepared by adding 3.144 g La(NO₃)₃.6H₂O (Lanthanum (III) nitrate, 99.9% (REO) (available from Alfa Aesar), 0.340 g Sr(OH)₂.6H₂O (Strontium hydroxide Tech. Gr. (available from Johnson Matthey Catalogue Corporation, Ward Hill, MA), 2.452g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the salts). The precursor was fired according to the following schedule: heat room temperature (RT) to 800° C. at 3° C. per min., hold for 1 hour, cool 800° C. to RT at 5° C. per min. An XRD image of the oxidized powder was similar to that produced with only nitrate salts.

### Example 7

### Infiltration of Dual Phase Cathode LSM/CeO₂

A 2 part LSM (La_{.85}Sr._{.15}MnO₃) 1 part lanthanum doped ceria (Ce.8La.202) precursor solution was prepared by adding 3.324 g La(NO₃)₃6H₂O (Lanthanum (III) nitrate, 99.9% (REO) (available from Alfa Aesar), 0.367 g Sr(NO₃)₂ (Strontium Nitrate, ACS, 99.0% min (Assay) (available from Alfa Aesar), 2.452 g Mn(NO₃)₂.6H₂O (Manganese (II) nitrate hydrate, 98% (available from Sigma-Aldrich), 1.483 g Ce(nO3)3.6H₂O (Cerium (III) nitrate hexahydrate, 99% (available from Aldrich) and 0.3 g Triton X-100 (available from VWR, West Chester, Pa.) in 10 mL of water (enough to dissolve the nitrates). The precursor was fired according to the following schedule: heat room temperature (RT) to 800° C. at 3° C. per min., hold for 1 hour, cool 800° C. to RT at 5° C. per min. An XRD image of the oxidized powder showed both LSM perovskite peaks (P) as well as doped ceria peaks (D).

### Example 8

### Fabrication of Anode Supported SOFC with LSM Infiltration Using Alternative Surfactant

An LSM (La_{.85}Sr_{.15}MnO₃) precursor solution was prepared in the same method as Example 1, except Triton x-100 was replaced by Darvan C (polymethylmetacrylic ammonium salt (PMMA), R.T. Vanderbilt Co.) in the same weight ratio. The precursor was fired according to the following schedule: heat room temperature (RT) to 800° C. at 3° C. per min., hold for 1 hour, cool 800° C. to RT at 5° C. per min. An XRD image of the oxidized powder was similar to that produced by Triton X-100.

### Example 9

### Anode Supported SOFC with LSF Cathode Plus Additional Co Catalyst

Preperation for the cell support up to infiltration was the same as in Example 1.

After cooling, the porous YSZ layer was infiltrated with an LSF (La_{.80}Sr_{.20}FeO_{3-δ}) (electronically conductive material) precursor solution. The solution was prepared by adding 2.980 g La(NO₃)₃.6H₂O (Lanthanum (III) nitrate, 99.9% (REO) (available from Alfa Aesar, Ward Hill, Mass.), 0.20 g Sr(NO₃)₂ (Strontium Nitrate, ACS, 99.0% min (Assay) (available from Alfa Aesar), 3.48 Fe(NO₃)₃.9H₂O (Iron (III) nitrate nonahydrate 98+% A.C.S reagent (available from Aldrich) and 0.3 g Triton X-100 (available from VWR, West Chester, Pa.) in 10 mL of water (enough to dissolve the nitrates).

Processing after infiltration was the same as in Example 1.

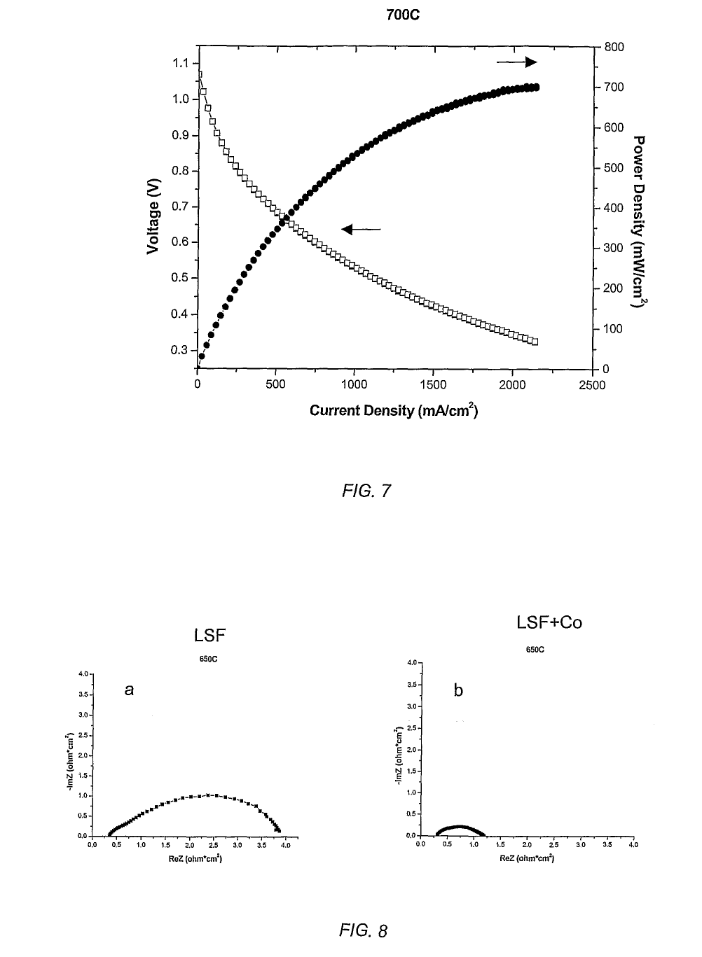

A plot of voltage and power vs. current density exemplifying the performance of the above cell at 700° C. is shown in FIG. 7.

After testing, the above cell was infiltrated with a Co (catalyst) precursor solution. A 1 molar solution of Co(NO₃)₂.6H₂O (Cobalt (II) nitrate, ACS, 89% (from Alfa Aesar) and (NH₂)₂CO (Urea (available from Mallinckrodt) in a (1:1 ratio by weight). The solution was then added dropwise to the now LSF infiltrated porous YSZ layer and heated to 90° C. for 2 hours. After, the disk was fired according to the following schedule: heat room temperature (RT) to 800° C. at 3° C. per min., hold for 0.5 hour, cool 800° C. to RT at 5° C. per min.

Processing after the infiltration was the same as in Example 1.

AC impedance data is plotted in FIG. 8 to exemplify the improvement that secondary infiltration has on the LSF cell. FIG. 8 shows plots of impedance spectra at 923K for the cell with a LSF infiltrated cathode (a) and with the infiltrated LSF infiltrated with additional Co (b).

### Example 10

### Anode Supported SOFC with Infiltrated Ag Cathode

The anode portion of an anode/electrolyte/cathode structure was formed by uniaxially pressing a mixture of NiO(50%)/SSZ(50 wt %). The mixture of NiO/SSZ was prepared by attritor milling 12.5 g of NiO (Nickelous Oxide, Green (available from Mallinckrodt Baker, Phillipsburg, N.J.), 12.5 g of SSZ ((Sc203)0.1(ZrO2)0.9, (available from Daiichi Kigenso Kagakukokyo) and 0.625 g each of fish oil (Sigma-Aldrich), dibutyl phthalate (Mallinckrodt Baker) and poly(vinyl butyral-co-vinyl alcohol-co-vinyl acetate) (available from Sigma-Aldrich) with 100 mL of (IPA), for 1 hour. The mixture was dried and then ground and sieved through a 100 mesh. A 1½ inch disk was then uniaxially pressed with 15 KPSI of pressure. The disk was fired to bum out the binders and sinter the structure, according to the following schedule: heat room temperature (RT) to 600° C. at 3° C. per min., 600° C. to 1100° C. at 5° C. per min., hold for 1 hours, cool 1100° C. to RT at 5° C. per min.

After cooling, a thin coating of SSZ (the ionically-conductive electrolyte material) was applied to the NiO/SSZ disk by uniformly spraying an SSZ suspension by an aerosol spray method. The suspension was prepared by attritor milling 2 g of SSZ, 0.1 g of fish oil (fish oil from Menhaden (available from Sigma-Aldrich, St. Louis, Mo.) and 0.01 g dibutyl phthalate (available from Mallinckrodt Balker) in 50 mL of Isopropyl Alcohol (IPA), for 1 hour. The suspension was sprayed while the NiO/SSZ disk was held at 150° C. (0.037 g of final dried SSZ was deposited, typically yielding a sintered SSZ electrolyte membrane about 10 μm thick). The disk was fired to burn our binders and sinter the structure, according to the following schedule: heat room temperature (RT) to 600° C. at 3° C. per min., 600° C. to 1350° C. at 5° C. per min., hold for 4 hours, cool 1350° C. to RT at 5° C. per min.

After cooling, a suspension of SSZ (35 vol %, ion-conductive material), and graphite (65 vol %, fugitive pore-forming material) was uniformly sprayed, by aerosol spray method, to a 1 cm area on the electrolyte surface. The suspension was prepared by attritor milling 1.28 g SSZ, 0.1 g fish oil (fish oil from Menhaden (Sigma-Aldrich) and 0.01 g dibutyl phthalate in 50 mL of IPA, for 1 hour. Afterwards 0.72 g of graphite (KS6 (available from Timcal Group, Quebec, Canada) was added and sonicated for 5 min. The electrolyte surface was been covered to only reveal a 1 cm² area which was then uniformly sprayed with the suspension, while being held at 150° C. (0.007 g of final dried SSZ/graphite was deposited, typically yielding a sintered porous SSZ membrane about 10 μm thick). The disk was fired to burn our fugitive pore formers and binders and sinter the structure, according to the following schedule: heat room temperature (RT) to 600° C. at 3° C. per min., 600° C. to 1250° C. at 5° C. per min., hold for 4 hours, cool 1250° C. to RT at 5° C. per min.

After cooling, the porous SSZ layer was infiltrated with an Ag (Ag) (electronically conductive material) precursor solution. The solution was prepared by adding 3.148 g AgNO₃ (Silver nitrate, ACS, 99.9+% (available from Alfa Aesar) and 0.3 g Triton X-100 (available from VWR, West Chester, Pa.) in 10 mL of water (enough to dissolve the nitrates). The solution was then heated to approximately 100° C. to evaporate the water in the solution (both the water added to the solution and that held by the nitrates). When the solutions internal temperature rises to about 100° C. most of the water has been evaporated. The hot solution (about 100° C.) was then added drop wise to the porous SSZ layer (the remaining electrolyte surface has again been covered to limit the infiltration area to 1 cm²) and vacuum impregnated. After drying at 120° C. for 30 min. the disk was fired according to the following schedule: heat room temperature (RT) to 900° C. at 3° C. per min., hold for 0.5 hour, cool 900° C. to RT at 5° C. per min.

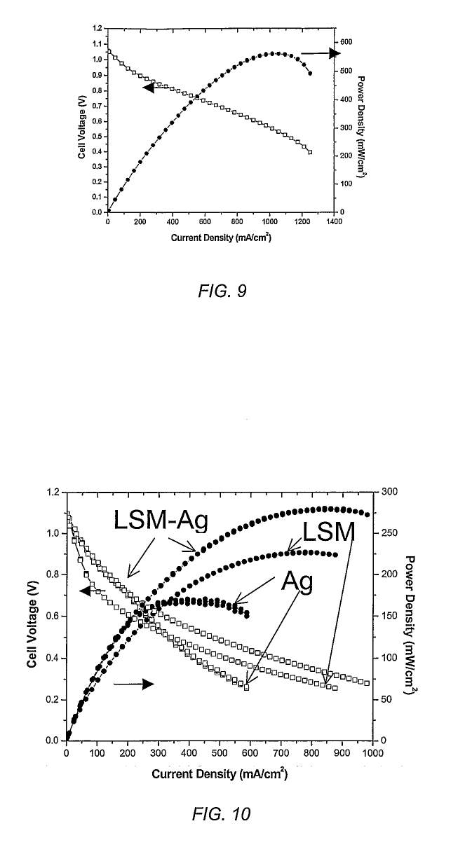

A plot of voltage and power vs. current density exemplifying the performance of the above cell at 750° C. is shown in FIG. 9.

### Example 11

### Anode Supported SOFC with LSM

Preparation for cell support up to infiltration was the same as in Example 10.

After cooling, the porous SSZ layer was infiltrated with an LSM (La_{.85}Sr_{.15}MnO₃) (electronically conductive material) precursor solution. The solution was prepared by adding 3.144 g La(NO₃)₃.6H₂O (Lanthanum (III) nitrate, 99.9% (REO) (available from Alfa Aesar, Ward Hill, Mass.), 0.271 g Sr(NO₃)₂ (Strontium Nitrate, ACS, 99.0% min (Assay) (available from Alfa Aesar), 2.452 g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the nitrates).

Processing after infiltration was the same as in Example 10.

A plot of voltage and power vs. current density exemplifying the performance of the above cell at 600° C. is shown in FIG. 10.

### Example 12

### Anode Supported SOFC with Composite Ag and LSM Cathode

Preparation for cell support up to infiltration was the same as in Example 10.

After cooling, the porous SSZ layer was infiltrated with an Ag-LSM (La_{.85}Sr_{.15}MnO₃) (50-50 volume %) (electronically conductive material) precursor solution. The solution was prepared by adding 1.934 g AgNO₃ (Silver nitrate, ACS, 99.9+% (available from Alfa Aesar), 1.214 g La(NO₃)₃.6H₂O (Lanthanum (III) nitrate, 99.9% (REO) (available from Alfa Aesar, Ward Hill, Mass.), 0.105 g Sr(NO₃)₂ (Strontium Nitrate, ACS, 99.0% min (Assay) (available from Alfa Aesar), 0.946 g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the nitrates).

Processing after infiltration was the same as in Example 10.

Voltage and power vs. current density were plotted to exemplify the performance of the LSM cell from Example 11, the Ag cell from Example 10, and the LSM-Ag cell in this example at 600° C. These are all shown in FIG. 10.

### Example 13

### Anode Supported SOFC with LSM-YSZ Sintered Cathode Infiltrated with LSM

The anode portion of an anode/electrolyte/cathode structure was formed by uniaxially pressing a mixture of NiO(50%)/YSZ(50 wt %). The mixture of NiO/YSZ was prepared by attritor milling 12.5 g of NiO (Nickelous Oxide, Green (available from Mallinckrodt Baker, Phillipsburg, N.J.), 12.5 g of YSZ (Tosoh TZ8Y) and 0.625 g each of fish oil (Sigma-Aldrich), dibutyl phthalate (Mallinckrodt Baker) and poly(vinyl butyral-co-vinyl alcohol-co-vinyl acetate) (available from Sigma-Aldrich) with 100 mL of (IPA), for 1 hour. The mixture was dried and then ground and sieved through a 100 mesh. A 1½ inch disk was then uniaxially pressed with 15 KPSI of pressure. The disk was fired to burn out the binders and sinter the structure, according to the following schedule: heat room temperature (RT) to 600° C. at 3° C. per min., 600° C. to 1100° C. at 5° C. per min., hold for 1 hours, cool 1100° C. to RT at 5° C. per min.

After cooling, a thin coating of YSZ (the ionically-conductive electrolyte material) was applied to the NiO/YSZ disk by uniformly spraying an YSZ suspension by an aerosol spray method. The suspension was prepared by attritor milling 2 g of YSZ, 0.1 g of fish oil (fish oil from Menhaden (available from Sigma-Aldrich, St. Louis, Mo.) and 0.01 g dibutyl phthalate (available from Mallinckrodt Baker) in 50 mL of Isopropyl Alcohol (IPA), for 1 hour. The suspension was sprayed while the NiO/YSZ disk was held at 150° C. (0.037 g of final dried SSZ was deposited, typically yielding a sintered YSZ electrolyte membrane about 10 μm thick). The disk was fired to bum our binders and sinter the structure, according to the following schedule: heat room temperature (RT) to 600° C. at 3° C. per min., 600° C. to 1400° C. at 5° C. per min., hold for 4 hours, cool 1400° C. to RT at 5° C. per min.

After cooling, a suspension of SSZ ((Sc2O3)0.1(ZrO2)0.9, (available from Daiichi Kigenso Kagakukokyo) and LSM (55 wt %, ion-conductive material), and graphite (45 wt %, fugitive pore-forming material) was uniformly sprayed, by aerosol spray method, to a 1 cm² area on the electrolyte surface. The suspension was prepared by attritor milling 1 g SSZ, 1 g LSM, 0.1 g fish oil (fish oil from Menhaden (Sigma-Aldrich) and 0.01 g dibutyl phthalate in 50 mL of IPA, for 1 hour. Afterwards 0.90 g of graphite (KS6 (available from Timcal Group, Quebec, Canada) was added and sonicated for 5 min. The electrolyte surface has been covered to only reveal a 1 cm² area which was then uniformly sprayed with the suspension, while being held at 150° C. (0.004 g of final dried LSM-SSZ/graphite was deposited, typically yielding a sintered porous LSM-SSZ membrane about 10 μm thick). The disk was fired to bum our fugitive pore formers and binders and sinter the structure, according to the following schedule: heat room temperature (RT) to 600° C. at 3° C. per min., 600° C. to 1250° C. at 5° C. per min., hold for 4 hours, cool 1250° C. to RT at 5° C. per min.

After cooling, the porous LSM-SSZ layer was infiltrated with an LSM (La_{.85}Sr_{.15}MnO₃) (electronically conductive material) precursor solution. The solution was prepared by adding 3.144 g La(NO₃)₃.6H₂O (Lanthanum (III) nitrate, 99.9% (REO) (available from Alfa Aesar, Ward Hill, Mass.), 0.271 g Sr(NO₃)₂ (Strontium Nitrate, ACS, 99.0% min (Assay) (available from Alfa Aesar), 2.452 g Mn(NO₃)₂.6H₂O (Manganese (II) nitrate hydrate, 98% (available from Sigma-Aldrich) and 0.3 g Triton X-100 (available from VWR, West Chester, Pa.) in 10 mL of water (enough to dissolve the nitrates).

Processing after infiltration was the same as in Example 10.

### Example 14

### Anode Supported SOFC with LSM-SSZ Cathode Infiltrated with Ag

Processing before infiltration was the same as in Example 13.

The porous LSM-SSZ layer was infiltrated with an Ag (electronically conductive material) precursor solution. The solution was prepared by adding 3.148 g AgNO₃ (Silver nitrate, ACS, 99.9+% (available from Alfa Aesar) and 0.3 g Triton X-100 (available from VWR, West Chester, Pa.) in 10 mL of water (enough to dissolve the nitrates).

Processing after infiltration was the same as in Example 10.

### Example 15

### Anode Supported SOFC with LSM-SSZ Cathode Infiltrated with CGO

Processing before infiltration was the same as in Example 13.

The porous LSM-SSZ layer was infiltrated with Ce_{.8}Gd_{.2}O₃ (CGO) precursor solution. The solution was prepared by adding 3.627 g Ce(NO₃)₃.6H₂O (Cerium (III) nitrate hexahydrate, REacton 99.5% (REO) (available from Alfa Aesar), 0.943 g Gd(NO₃)₃.XH₂O (X≈6) (Gadolinium (III) nitrate hydrate 99.9% (REO) (available from Alfa Aesar) and 0.3 g Triton X-100 (available from VWR, West Chester, Pa.) in 10 mL of water (enough to dissolve the nitrates).

Processing after infiltration was the same as in Example 10.

### Example 16

### Ni—YSZ anode infiltrated with CGO

An anode structure was formed by uniaxially pressing a mixture of NiO(50%)/YSZ(50 wt %). The mixture of NiO/YSZ was prepared by attritor milling 12.5 g of NiO (Nickelous Oxide, Green (available from Mallinckrodt Baker, Phillipsburg, N.J.), 12.5 g of YSZ (Tosoh TZ8Y) and 0.625 g each of fish oil (Sigma-Aldrich), dibutyl phthalate (Mallinckrodt Baker) and poly(vinyl butyral-co-vinyl alcohol-co-vinyl acetate) (available from Sigma-Aldrich) with 100 mL of (IPA), for 1 hour. The mixture was dried and then ground and sieved through a 100 mesh. A 1½ inch disk was then uniaxially pressed with 15 KPSI of pressure. The disk was fired to burn out the binders and sinter the structure, according to the following schedule: heat room temperature (RT) to 600° C. at 3° C. per min., 600° C. to 1400° C. at 5° C per min., hold for 1 hours, cool 1400° C. to RT at 5° C. per min.

The above cell was then infiltrated with Ce_{.8}Gd_{.2}O₃ (CGO) precursor solution. The solution was prepared by adding 3.627 g Ce(NO₃)₃.6H₂O (Cerium (III) nitrate hexahydrate, REacton 99.5% (REO) (available from Alfa Aesar), 0.943 g Gd(NO₃)₃.XH₂O (X≈6) (Gadolinium (III) nitrate hydrate 99.9% (REO) (available from Alfa Aesar) and 0.3 g Triton X-100 (available from VWR, West Chester, Pa.) in 10 mL of water (enough to dissolve the nitrates).

The cell was then reduced in a hydrogen furnace at 800° C. to convert the NiO to Ni.

Conclusion

Although the foregoing invention has been described in some detail for purposes of clarity of understanding, it will be apparent that certain changes and modifications may be practiced within the scope of the appended claims. In particular, while the invention is primarily described with reference to LSM-YSZ composite electrodes for use in solid oxide fuel cells, other material combinations and associated precursors, including those described in the Examples, and others which would be readily apparent to those of skill in the art given the disclosure herein, may be used to form mixed electrodes for SOFCs or other electrochemical devices in accordance with the present invention. In addition, the infiltration technique of the present invention may find application beyond electrochemical device fabrication. It should be noted that there are many alternative ways of implementing both the process and compositions of the present invention. Accordingly, the present embodiments are to be considered as illustrative and not restrictive, and the invention is not to be limited to the details given herein.

All references cited herein are incorporated by reference for all purposes.

1. A method of forming a particulate layer on the pore walls of a porous structure comprising:
forming a solution comprising at least one metal salt and a surfactant;
heating the solution to substantially evaporate solvent and form a concentrated salt and surfactant solution;
infiltrating the concentrated solution into a porous structure to create a composite; and
heating the composite to substantially decompose the salt and surfactant to oxide and/or metal particles;
whereby a particulate layer of oxide and/or metal particles is formed on the porous structure.

2. The method of claim 1, wherein the particulate layer is a continuous network.

3. The method of claim 2, wherein the continuous network is electronically conductive.

4. The method of claim 2, wherein the continuous network is ionically conductive.

5. The method of claim 2, wherein the continuous network is a mixed ionic-electronic conductor (MIEC).

6. The method of claim 1, wherein the solution comprises a single metal salt.

7. The method of claim 1, wherein the solution comprises a plurality of metal salts.

8. The method of claim 7, wherein the solution comprises three metal salts.

9. The method of claim 7, wherein the solution comprises metal salts that are precursors for LSM.

10. The method of claim 1, wherein the porous structure is an ionically conductive material.

11. The method of claim 10, wherein the porous structure is YSZ.

12. The method of claim 10, wherein the porous structure is SSZ.

13. The method of claim 1, wherein the porous structure is a mixed ionic-electronic conductor (MIEC).

14. The method of claim 13, wherein the porous structure is a LSM-YSZ composite.

15. The method of claim 1, wherein the continuous network is a single phase perovskite.

16. The method of claim 15, wherein the porous structure comprises YSZ and the connected particulate layer comprises LSM.

17. The method of claim 1, wherein the metal salt and surfactant solution is heated to between about 70-130° C.

18. The method of claim 1, wherein the metal salt and surfactant solution initially further comprises water and the solution is heated to about 110° C.

19. The method of claim 1, wherein the infiltration is conducted in a single step.

20. The method of claim 1, wherein the infiltration is conducted in a plurality of steps.

21. The method of claim 1, wherein the composite formed by the infiltration is heated to a temperature above 500° C.

22. The method of claim 1, wherein the composite formed by the infiltration is heated to a temperature between about 500 and 800° C.

23. The method of claim 1, wherein the composite formed by the infiltration is heated to a temperature of about 800° C.

24. An electrochemical device comprising:
a mixed cathode comprising,
a porous structure, a particulate layer of oxide and/or metal particles on the pore walls of the porous structure;
wherein the layer is formed by a single infiltration of the porous structure with a metal salt and surfactant solution.

25. The device of claim 24, wherein the porous structure is ionically conductive and the particulate network is electronically conductive.

26. The device of claim 25, wherein the porous structure comprises YSZ and the connected particulate layer comprises LSM.

27. The device of claim 26, wherein the device is a SOFC.

28. The device of claim 24, wherein the device is an oxygen generator.

29. The device of claim 24, wherein the device is a hydrocarbon reformer.

30. A method of forming a particulate layer on the pore walls of a porous structure comprising:
forming a solution comprising at least one metal salt and a surfactant;
heating the solution to between about 70 and 130° C. to form a concentrated salt and surfactant solution;
infiltrating the concentrated solution into a porous structure to create a composite; and
heating the composite to a temperature greater than 500° C.;
whereby a network of oxide and/or metal particles is formed on the porous structure.

31. (canceled)
